(19) United States
(12) Patent Application Publication
(10) Pub. No.: US 2015/0101004 A1
(43) Pub. Date: Apr. 9, 2015

(54) RECEIVER APPARATUS AND SYNCHRONIZATION PROCESSING METHOD THEREOF

(71) Applicant: SONY CORPORATION, Tokyo (JP)

(72) Inventor: Naohisa Kitazato, Tokyo (JP)

(73) Assignee: SONY CORPORATION, Tokyo (JP)

(21) Appl. No.: 14/399,306

(22) PCT Filed: Jun. 5, 2013
(86) PCT No.: PCT/JP2013/003521

§ 371 Date: Nov. 6, 2014

(30) Foreign Application Priority Data
Jun. 22, 2012 (JP) 2012-141034

(51) Int. Cl. H04N 21/43

(52) U.S. Cl. CPC H04N 21/4302
USPC 725/131

(57) ABSTRACT

[Object] When two image streams to be synchronized and reproduced are separately transmitted by broadcasting and by the Internet, to successfully synchronize and reproduce the two image streams.

[Solving Means] A receiver apparatus includes: a broadcast receiver capable of receiving one of a plurality of images as a broadcast stream via broadcasting, a time reference value being added to the plurality of images, the plurality of images being to be synchronized and reproduced; a communication receiver capable of receiving the other of the plurality of images as a communication stream via a network; a criterion time generator configured to generate criterion time based on the time reference value of the broadcast stream, the criterion time being used to generate timing to present the plurality of images; and an adjuster configured to adjust the criterion time based on an amount of delay of the time reference value of the communication stream behind the criterion time.

### TECHNICAL FIELD

The present invention relates to: a receiver apparatus capable of receiving one of a plurality of images to be synchronized and reproduced by broadcasting, receiving the other via a network, and synchronizing and reproducing them; and a synchronization processing method thereof.

### BACKGROUND ART

Wider frequency band for broadcasting may not be expected in the future in the face of growing demands for wider frequency band for communication such as mobile phones in recent years. Meanwhile, a larger frequency band is required to transmit content (e.g., 3D program, high-resolution image, etc.), and it is expected that the frequency for broadcasting will not be enough. In view of this, a service, which uses broadcasting and the Internet in an integrative manner and transmits a program requiring a wider frequency band such as a 3D program or a high-resolution image, is under consideration.

For example, Patent Document 1 discloses a technology including: transmitting main broadcast audio data as a broadcast wave; transmitting multi-viewpoint image data and multi-auditory point audio data via a network; and receiving and presenting, by a receiver apparatus, the main broadcast audio data, the multi-viewpoint image data, and the multi-auditory point audio data.

Patent Document 1: Japanese Patent Application Laid-open No. 2005-159592

### SUMMARY OF INVENTION

### Problem to be Solved by the Invention

When two image streams to be synchronized and reproduced are separately transmitted by broadcasting and by the Internet, if the receiving timing of one image stream is different from the receiving timing of the other image stream because of difference of characteristics of the transmitting methods, i.e., especially if a stream via the Internet is behind a broadcast stream and the buffer at the broadcast receiver side cannot absorb the amount of delay, it may be difficult to synchronize and reproduce those image streams.

In view of the above-mentioned circumstances, it is an object of the present technology to provide: a receiver apparatus capable of, when two image streams to be synchronized and reproduced are separately transmitted by broadcasting and by the Internet, successfully synchronizing and reproducing the two image streams; and a synchronization processing method thereof.

### Means for Solving the Problem

To solve the above-mentioned problems, according to the present technology, a receiver apparatus includes: a broadcast receiver capable of receiving one of a plurality of images as a broadcast stream via broadcasting, a time reference value being added to the plurality of images, the plurality of images being to be synchronized and reproduced; a communication receiver capable of receiving the other of the plurality of images as a communication stream via a network; a criterion time generator configured to generate criterion time based on the time reference value of the broadcast stream, the criterion time being used to generate timing to present the plurality of images; and an adjuster configured to adjust the criterion time based on an amount of delay of the time reference value of the communication stream behind the criterion time.

In the receiver apparatus, the adjuster is configured to adjust the criterion time based on an amount of delay of the time reference value of the communication stream behind the criterion time, the criterion time being generated based on the time reference value of the broadcast stream. As a result, it is possible to synchronize and reproduce the streams even if the communication stream is received after the broadcast stream.

The adjuster may be configured to adjust the criterion time based on the amount of delay of the time reference value of the communication stream received by the communication receiver for the first time.

Presentation time information may be added to each predetermined unit of the broadcast stream, and presentation time information is added to each predetermined unit of the communication stream, and the receiver apparatus may further include a broadcast-receiver image decoder configured to decode the broadcast stream received by the broadcast receiver such that the one image is to be presented at the timing when the presentation time information added to the broadcast stream coincides with the criterion time, a broadcast-receiver image decoder configured to decode the communication stream received by the communication receiver such that the other image is to be presented at the timing when the presentation time information added to the communication stream coincides with the criterion time, and an image merger configured to merge a plurality of images decoded by the broadcast-receiver image decoder and the communication-receiver image decoder.

The adjuster may be configured to adjust the criterion time based on a value obtained by adding a predetermined margin to an average value of the amounts of delay of the time reference values of the communication stream received by the communication receiver within a certain time period.

Presentation time information may be added to each predetermined unit of the broadcast stream out of the broadcast stream and the communication stream, and the receiver apparatus may further include a broadcast-receiver image decoder configured to decode the broadcast stream received by the broadcast receiver such that the one image is to be presented at the timing when the presentation time information added to the broadcast stream coincides with the criterion time, a broadcast-receiver image decoder configured to decode the communication stream received by the communication receiver, and an image merger configured to merge a plurality of images decoded by the broadcast-receiver image decoder and the communication-receiver image decoder.

It is supposed that, in the receiver apparatus, presentation time information is added to each predetermined unit of the broadcast stream out of the broadcast stream and the communication stream, and no presentation time information is added to the communication stream. In view of the above-mentioned supposition, the adjuster may be configured to adjust the criterion time based on a value obtained by adding a predetermined margin to an average value of the amounts of delay of the time reference values of the communication stream received by the communication receiver within a certain time period. In other words, the receiver apparatus receives and decodes the communication stream having no presentation time information again and again, and reproduces the communication stream. Because of this, an average value of the amounts of delay obtained within a certain time period is preferably used to adjust the criterion time instead of an obtained local amount of delay. Moreover, because delay of a communication stream behind a broadcast stream is fatal to synchronization and reproduction, it is effective to adjust a criterion time based on a value obtained by adding a margin to the average value.

According to another aspect of the present technology, a synchronization processing method is characterized in that the method includes: receiving one of a plurality of images as a broadcast stream via broadcasting, a time reference value being added to the plurality of images, the plurality of images being to be synchronized and reproduced; receiving the other of the plurality of images as a communication stream via a network; generating, by a criterion time generator, criterion time based on the time reference value of the broadcast stream, the criterion time being used to generate timing to present the plurality of images; and adjusting, by an adjuster, the criterion time based on an amount of delay of the time reference value of the communication stream behind the criterion time.

### Effect of the Invention

As described above, according to the present technology, it is possible to, when two image streams to be synchronized and reproduced are separately transmitted by broadcasting and by the Internet, successfully synchronize and reproduce the two image streams.

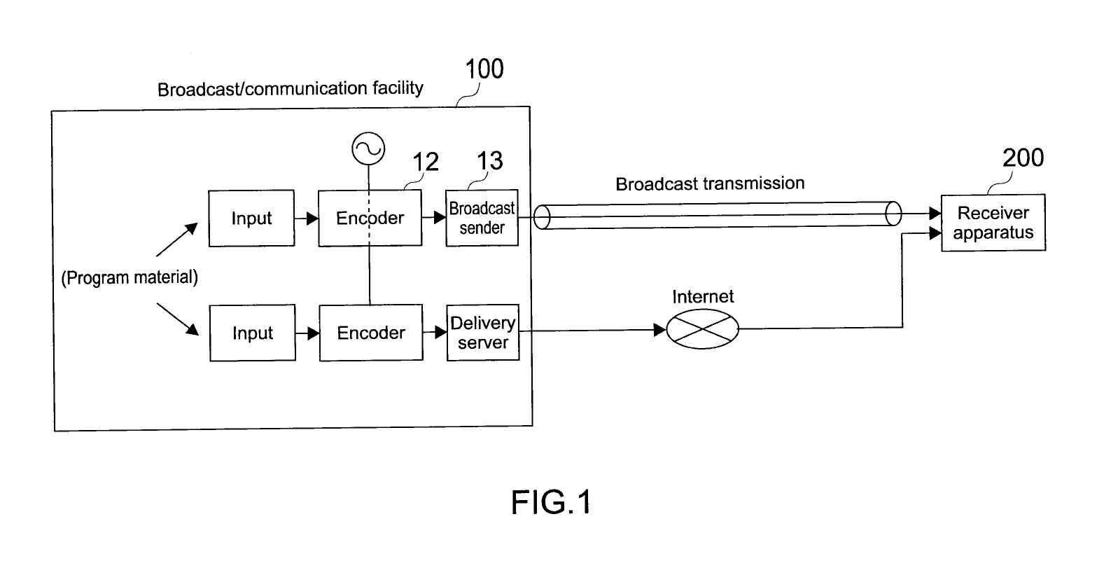

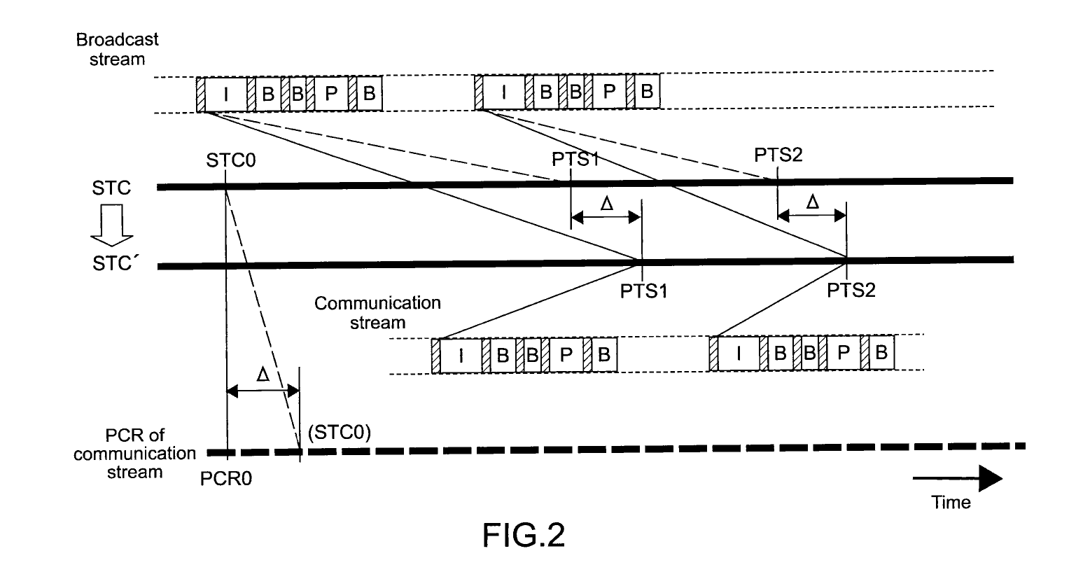

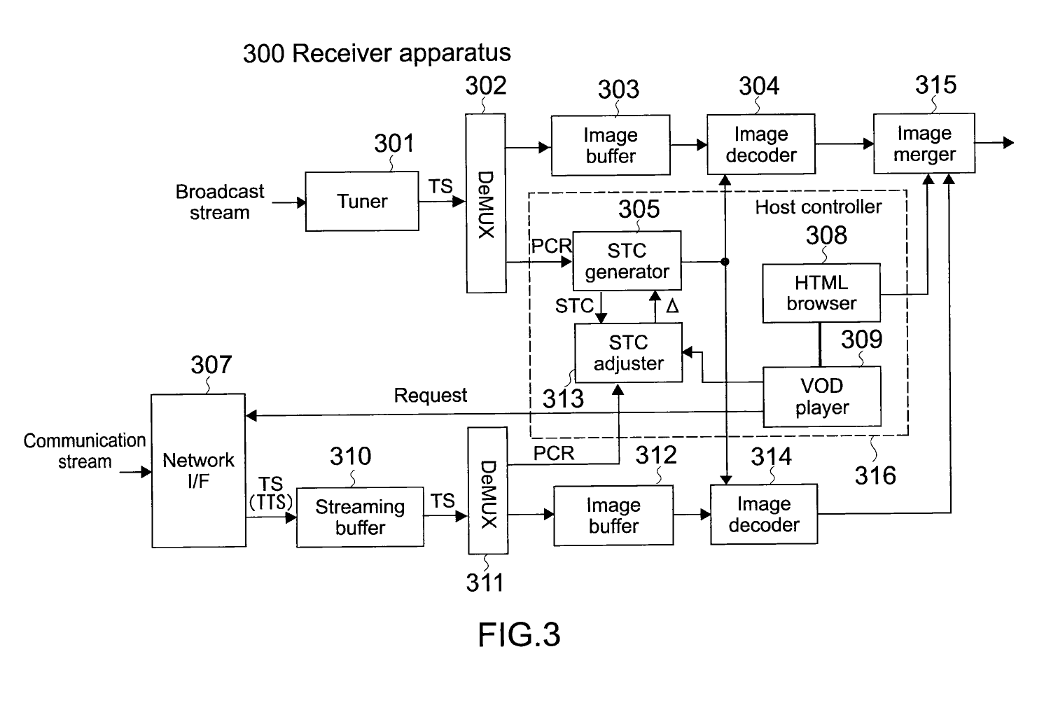

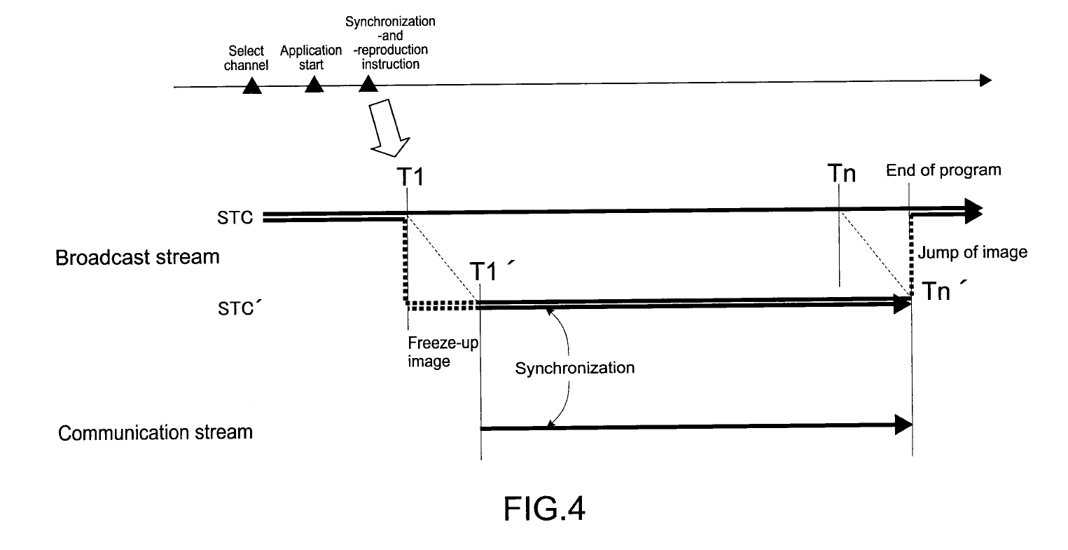

### BRIEF DESCRIPTION OF DRAWINGS

[FIG. 1] A diagram showing the configuration of a system for synchronizing and transmitting a broadcast stream and a communication stream.

[FIG. 2] A timing diagram showing an operation in which a receiver apparatus according to a first embodiment of the present technology adjusts the STC and thus synchronizes a broadcast stream and a communication stream.

[FIG. 3] A block diagram showing the configuration of a receiver apparatus according to the first embodiment.

[FIG. 4] A timing diagram showing firstly selection of a broadcast channel, processing of synchronizing a broadcast stream and a communication stream, and finally the end of the synchronization processing.

### MODES FOR CARRYING OUT THE INVENTION

Hereinafter, embodiments of the present technology will be described.

### First Embodiment

This embodiment relates to: a receiver apparatus configured to receive a stream (hereinafter referred to as “broadcast stream”.) containing images transmitted by broadcasting and a stream (hereinafter referred to as “communication stream”.) containing images transmitted by the Internet, and to synchronize and reproduce them; and its synchronization processing method.

Examples of such a system for synchronizing and transmitting a broadcast stream and a communication stream include the following.

1. 3D Program

FIG. 1 is a diagram showing the configuration of a 3D program transmitting system.

The image from one viewpoint out of images from a plurality of viewpoints, which configure a 3D program, is transmitted by broadcasting, and the image from the other viewpoint is transmitted by communication. A receiver receives the two images transmitted by broadcasting and by communication, synchronizes, reproduces, and merges them, and presents a 3D image.

2. Multi-View Program

A plurality of cameras take images of one object simultaneously, an obtained image of one view, i.e., a main-view, is transmitted by broadcasting, and the other images of one or more views, i.e., sub-views, are transmitted by communication. A receiver receives those images of the plurality of views, and displays the main-view image in a main-window and displays the one or more sub-view images in sub-windows at the same time. Alternatively, the receiver alternately selects one of the main-view and the sub-views as an image displayed on a main-window.

3. High-Resolution Program

For example, an image taken by a high-resolution camera of 4K (number of pixels: 3840×2160) is divided in quarters, whereby four-block images each having a HD size (number of pixels: 1920×1080) are obtained. Some of them are transmitted by broadcasting, and the others are transmitted by communication. A receiver receives the four-block images each having a HD size, synchronizes, reproduces, and merges them, and presents a high-resolution image having a 4K size. Alternatively, an image taken by a high-resolution camera is frequency-resolved by wavelet transform or the like, an image having a HD size having low-resolution components is transmit by broadcasting, and the rest images having high-frequency components are transmitted by communication. A receiver frequency-synchronizes the received four images each having the HD size by wavelet inverse transform or the like, and reconstructs and presents one high-resolution image.

4. Dubbing Service

In a dubbing service, an image and the Japanese speech are transmitted by broadcasting, and multilingually-dubbed speech for that image is transmitted by communication. A receiver receives the image and the Japanese speech by broadcasting and receives the multilingually-dubbed speech of the image by communication at the same time, and synchronizes, reproduces, and presents the broadcast image and the dubbed-speech in response to a request from a user.

FIG. 1 is a diagram showing the configuration of the above-mentioned system for synchronizing and transmitting a broadcast stream and a communication stream.

Here, examples of a program material include a 3D program, a multi-view program, a high-resolution program, a dubbing service program, and the like. The broadcast/communication facility 100 divides a program material into a signal for broadcasting and a signal for communication. Each encoder encodes the signal for broadcasting or the signal for communication into a stream of MPEG2_TS or the like. One stream is transmitted by broadcasting, and the other stream is delivered from a delivery server by communication via the Internet. When encoding, a PCR (Program Clock Reference), i.e., a periodic time reference value, is inserted into each video TS packet. Alternatively, PCR packets each containing a PCR are added periodically.

Typically, a receiver apparatus 200 receives a broadcast stream and a communication stream of one program. Typically, the receiver apparatus 200 extracts PCRs from the received broadcast stream and PCRs from the communication stream, and sets up or calibrates the STC (System Time Clock), i.e., the criterion time of the receiver apparatus 200, based on the PCRs. The image presentation timing is generated based on the STC and PTSs (Presentation Time Stamps), i.e., presentation time information contained in image TS packets.

At this time, because of traffic changes of the network, the receiver apparatus 200 may receive a communication stream after a broadcast stream, which is to be synchronized with the communication stream and reproduced. If a communication stream is behind a broadcast stream, it is necessary to store a received broadcast stream in a buffer and to thus delay reproduction of the broadcast stream. However, typically, it is presupposed that the receiver apparatus 200 uniquely determines image stream presentation timing based on the STC, which is generated based on PCRs, and based on PTSs, i.e., time managing information of reproduction, in image TS packets. Because of this, actually, it is difficult to synchronize and reproduce a broadcast stream and a communication stream only by storing a received broadcast stream in a buffer.

In view of this, in this embodiment, there is employed a scheme in which, if the STC of the receiver apparatus is larger than the PCR inserted in the first image TS packet of a received communication stream, the difference is subtracted from the STC value for adjustment.

FIG. 2 is a timing diagram showing an operation in which a receiver apparatus 300 according to a first embodiment of the present technology adjusts the STC and thus synchronizes a broadcast stream and a communication stream.

1. The receiver apparatus 300 compares the PCR value obtained from the first image TS packet of a received communication stream after an instruction to synchronize and reproduce a broadcast stream and a communication stream is generated, i.e., PCR0, to the current STC value of the receiver apparatus 300, i.e., STC0, and determines if the condition STC0>PCR0 is satisfied.

2. If the above-mentioned condition is satisfied, the receiver apparatus 300 calculates the offset Δ of STC0 and PCR0 based on the following formula.

STC0−PCR0=Δ (1)

3. The receiver apparatus 300 adjusts the STC based on the following formula, in which the offset Δ is used.

STC−Δ=STC′ (2)

4. The receiver apparatus 300 refers to PTSs of image TS packets of a broadcast stream, PTSs of image TS packets of the communication stream, and the STC′, and controls timing of presentation of images thereof. Specifically, each of a broadcast stream and a communication stream is controlled such that an image is presented when the PTS of an image TS packet coincides with the STC′.

According to the above-mentioned process, it is possible to synchronize and reproduce a broadcast stream and a communication stream.

[Configuration of Receiver Apparatus]

FIG. 3 is a block diagram showing the configuration of the receiver apparatus 300 of this embodiment.

The receiver apparatus 300 includes a tuner 301 (broadcast receiver), a broadcast-receiver DeMUX 302, a broadcast-receiver image buffer 303, a broadcast-receiver image decoder 304 (first image decoder), an STC generator 305 (criterion time generator), a network I/F 307 (communication receiver), an HTML browser 308, a VOD player 309, a communication-receiver streaming buffer 310, a communication-receiver DeMUX 311, a communication-receiver image buffer 312, an STC adjuster 313 (adjuster), a communication-receiver image decoder 314, and an image merger 315.

The tuner 301 receives a broadcast stream (first image stream) of a channel selected by a user, generates a transport stream (TS), and transmits the transport stream to the broadcast-receiver DeMUX 302.

The broadcast-receiver DeMUX 302 demultiplexes the transport stream, separates image TS packets therefrom, supplies the TS packets to the broadcast-receiver image buffer 303 as an image stream, extracts PCRs from the image TS packets, and supplies the PCRs to the STC generator 305.

The broadcast-receiver image buffer 303 buffers the image stream to be supplied to the broadcast-receiver image decoder 304.

The broadcast-receiver image decoder 304 decodes the image stream read from the broadcast-receiver image buffer 303, and outputs a broadcast-series image signal to the image merger 315.

The STC generator 305 generates an STC of 27 MHz with reference to the PCRs extracted from a broadcast stream, and supplies the STC to the broadcast-receiver image decoder 304, the communication-receiver image decoder 314, and the like.

Broadcast-related application software, which is operated by an HTML (HyperText Markup Language) browser 308, outputs an instruction to obtain a communication stream to the VOD (Video On Demand) player 309, whereby the VOD player 309 supplies a request. The network I/F 307 sends the request to a delivery server of the broadcast/communication facility 100 via the Internet, and receives a communication stream, which is to be synchronized with a broadcast stream and reproduced, as a response from the delivery server.

The communication-receiver streaming buffer 310 buffers the received communication stream. Here, if the image TS packets, i.e., the received communication stream, are TTS (Timestamped TS) packets containing PTSs, the communication-receiver streaming buffer 310 continuously retrieves a stored communication stream to obtain as many TS packets at an original rate as possible by using the PTSs, and supplies the communication stream to the communication-receiver DeMUX 311.

The communication-receiver DeMUX 311 separates image TS packets from a communication stream retrieved from the streaming buffer 310, and supplies the image TS packets to the communication-receiver image buffer 312 as an image stream, extracts the PCR from the front TS packet of the received image stream, and supplies the PCR to the STC adjuster 313.

The communication-receiver image buffer 312 buffers the image stream to be supplied to the communication-receiver image decoder 314.

The communication-receiver image decoder 314 decodes the image stream retrieved from the communication-receiver image buffer 312, and outputs a communication-related image signal to the image merger 315.

The image merger 315 merges the broadcast-related image signal and the communication-related image signal, generates an image signal to be presented, and outputs the image signal to a not-shown display. Here, the image signals are merged based on a method corresponding to a method of separating a program material (3D program, multi-view program, high-resolution program, dubbing service program, etc.) into broadcasting and communication.

The STC adjuster 313 compares the STC of the STC generator 305 to the PCR supplied from the communication-receiver DeMUX 311, generates data-for-adjusting-STC (offset Δ), and outputs the data-for-adjusting-STC (offset Δ) to the STC generator 305.

The STC generator 305 adjusts the STC based on the data-for-adjusting (offset Δ) from the STC adjuster 313.

A host controller 316 includes a CPU (Central Processing Unit), a ROM (Read Only Memory), a RAM (Random Access Memory), and the like. The ROM fixedly stores programs executed by the CPU and data. The programs stored in the ROM are loaded in the RAM, and the CPU executes the loaded programs.

The programs loaded in the RAM cause the host controller 316 to operate as for example the STC generator 305, the HTML browser 308, the VOD player 309, and the STC adjuster 313. Note that the STC generator 305 and the STC adjuster 313 may not be software but may be hardware. The host controller 316 is capable of receiving various kinds of instructions and data input by a user by using a not-shown remote control, for example.

[Processing of Synchronizing Broadcast Stream and Communication Stream]

Next, operations from selection of a broadcast channel to synchronized reproduction of a broadcast stream and a communication stream, which are performed by the receiver apparatus 300, will be described.

Firstly, a user of the receiver apparatus 300 selects a broadcast channel by using a not-shown remote control or the like. The host controller 316 processes selected-channel information, which is input by the user and received by the remote control or the like. The host controller 316 controls the tuner 301 based on the selected-channel information input by the user.

The tuner 301 transmits a broadcast stream of the received channel to the broadcast-receiver DeMUX 302. The DeMUX 302 separates image TS packets, audio TS packets, and the other TS packets such as SI (Service Information: program array information) from the broadcast stream. The broadcast-receiver DeMUX 302 supplies the separated image TS packets, i.e., an image stream, to the broadcast-receiver image buffer 303. The broadcast-receiver image buffer 303 temporarily stores the image stream.

Moreover, the broadcast-receiver DeMUX 302 constantly extracts PCRs from the image TS packets, and supplies the PCRs to the STC generator 305. The STC generator 305 generates a STC (System Time Clock) of 27 MHz with reference to the PCRs.

The broadcast-receiver image decoder 304 decodes the image stream read from the broadcast-receiver image buffer 303, and supplies an image signal to the image merger 315. At this time, the broadcast-receiver image decoder 304 controls decoding-and-output timing of the image stream such that the image is to be presented at times when the PTSs (Program Clock Reference) of the image TS packets coincide with the STC from the STC generator 305.

The broadcast-series image signal output from the broadcast-receiver image decoder 304 is output to the image merger 315.

As an example of this operation, it is presupposed that, after a channel is selected, the receiver apparatus 300 obtains application software (broadcast-related application software) related to the channel or a program by broadcasting or communication, and executes the application software. The broadcast-related application software causes the receiver apparatus 300 to: allow a user to watch, for example, a 3D program, a multi-view program, a high-resolution program, a dubbing service program, or the like, in which a broadcast stream and a communication stream are synchronized and reproduced; receive a watch-instruction from a user; and then cause the VOD player 309 to supply an instruction to obtain a communication stream.

Note that the broadcast-related application software includes, for example, HTML (Hyper Text Markup Language) documents, BML documents (Broadcast Markup Language), MHEG documents (Multimedia and Hypermedia information coding), Java (registered trademark) scripts, still-image files, moving-image files, and the like.

If the VOD player 309 receives the instruction to obtain a communication stream, the VOD player 309 causes the network I/F 307 to send a request to transmit a communication stream (communication stream to be synchronized with broadcast stream and reproduced) related to the selected channel or a program to a delivery server via the Internet, and supplies an instruction to adjust the STC to the STC adjuster 313. The STC adjuster 313 receives the instruction to adjust the STC, and then waits for a PCR to be supplied from the communication-receiver DeMUX 311.

Meanwhile, the communication-receiver streaming buffer 310 stores a communication stream transmitted from the delivery server via the network I/F 307 in response to the request. Here, the communication-receiver streaming buffer 310 stores the front image TS packet of the communication stream, reads the front image TS packet immediately after that, and supplies the front image TS packet to the communication-receiver DeMUX 311.

Note that the communication-receiver streaming buffer 310 stores a communication stream in a burst mode. If the image TS packets transmitted from the delivery server are TTS packets containing PTSs, the streaming buffer 310 continuously retrieves a stored communication stream to obtain as many TS packets at an original rate as possible by using the PTSs, and supplies the communication stream to the communication-receiver DeMUX 311.

The communication-receiver DeMUX 311 separates image TS packets from the communication stream read from the streaming buffer 310, supplies the image TS packets to the communication-receiver image buffer 312, extracts the PCR from the image TS packet obtained for the first time, and supplies the PCR to the STC adjuster 313.

Here, the value of the PCR extracted from the image TS packet obtained for the first time will be referred to as PCR0. The STC adjuster 313 obtains the PCR0, then compares the PCR0 to the value (STC0) of the STC supplied from the STC generator 305, and determines if the condition STC0>PCR0 is satisfied or not. If STC0>PCR0 is satisfied, then it means that the communication stream is received after a broadcast stream, the communication stream being to be synchronized with the broadcast stream and reproduced.

If the condition STC0>PCR0 is satisfied, the STC adjuster 313 calculates the offset of STC0 and PCR0 based on the following formula.

STC0−PCR0=Δ (1)

The value of the offset is supplied to the STC generator 305.

The STC generator 305 receives the value of the offset Δ, and then adjusts the STC based on the following formula.

STC−1=STC′ (2)

As described above, the STC is adjusted, and the STC′, which is displaced by an amount of delay of the communication stream behind the broadcast stream, is set. After that, each of the broadcast-receiver image decoder 304 and the communication-receiver image decoder 314 controls the timing of presentation of each image stream based on the STC′. As a result, the broadcast stream and the communication stream are synchronized and reproduced.

Because the synchronized broadcast-related image signal and communication-related image signal are supplied to the image merger 315, an original program such as a 3D program, a multi-view program, a high-resolution program, or a dubbing service program is reconstructed accurately.

Note that if the condition STC0>PCR0 is satisfied, the STC is adjusted. To the contrary, if STC0<PCR0 or STC0=PCR0 is satisfied, it is not necessary to adjust the STC.

Moreover, the STC′ is corrected to the original STC simultaneously with the end of the broadcast program decoded based on the STC′.

FIG. 4 is a timing diagram showing firstly selection of a broadcast channel, processing of synchronizing a broadcast stream and a communication stream, and finally the end of the synchronization processing, which have been described above.

The receiver apparatus 300 updates the STC with the STC′. As a result, the time T1 to start decoding an image stream is delayed, and the time T1′ is set. A freeze-up image is displayed between T1 and T1′. Then decoding of a broadcast image stream and a communication image stream is restarted at the time T1′. After that, decoding is performed with reference to the STC′ until the end of the program. When the program is finished, the STC is used again instead of the STC′, an access unit whose PTS coincides with the STC is selected, and decoding is performed.

### Second Embodiment

In the above-mentioned first embodiment, it is supposed that image TS packets of a communication stream are TTS packets. Alternatively, image TS packets of a communication stream may be TS packets containing no PTSs.

In this case, the series from the streaming buffer 310 to the image decoder 314 repeats the operation from receiving of a communication stream to decoding again and again irrespective of the STC. Because of this, a broadcast stream and a communication stream may sometimes not be synchronized properly only by adjusting the STC based on the difference between the PCR0, which is extracted from the image TS packet received for the first time, and the STC0.

In view of the above-mentioned supposition, it is necessary to obtain an offset Δ as an average amount of delay of a communication stream behind a broadcast stream.

For example, differences of the STC and PCRs within a certain time period from the start of receiving a communication stream are calculated, and the average value of the differences is obtained based on the following formula.

[Math 1]

A=1/N×Σ(STCi−PCRi) (3)

If the value A is positive, a margin m is added to A, whereby the offset Δ is obtained.

The STC generator 305 subtracts the offset Δ from STC, and supplies the result, i.e., the adjusted STC′, to the broadcast-receiver image decoder 304 and the like. Then the broadcast-receiver image decoder 304 controls the timing of presentation of the image stream based on the STC′.

TS packets containing no PTSs are originally used to transmit a medium, which does not require accurate synchronizing. So the STC is adjusted sufficiently based on the offset Δ, which is obtained as the average amount of delay of a communication stream behind a broadcast stream.

The present technology is not limited to the above-mentioned illustrated examples, and may be variously modified within the gist of the present invention, as a matter of course.

Note that the present technology may employ the following configurations.

(1) A receiver apparatus, including:

a broadcast receiver capable of receiving one of a plurality of images as a broadcast stream via broadcasting, a time reference value being added to the plurality of images, the plurality of images being to be synchronized and reproduced;

a communication receiver capable of receiving the other of the plurality of images as a communication stream via a network;

a criterion time generator configured to generate criterion time based on the time reference value of the broadcast stream, the criterion time being used to generate timing to present the plurality of images; and

an adjuster configured to adjust the criterion time based on an amount of delay of the time reference value of the communication stream behind the criterion time.

(2) The receiver apparatus according to (1), in which

The receiver apparatus according to claim 1, in which

the adjuster is configured to adjust the criterion time based on the amount of delay of the time reference value of the communication stream received by the communication receiver for the first time.

(3) The receiver apparatus according to (1) or (2), in which

presentation time information is added to each predetermined unit of the broadcast stream, and presentation time information is added to each predetermined unit of the communication stream, and

the receiver apparatus further comprises

a broadcast-receiver image decoder configured to decode the broadcast stream received by the broadcast receiver such that the one image is to be presented at the timing when the presentation time information added to the broadcast stream coincides with the criterion time,

a broadcast-receiver image decoder configured to decode the communication stream received by the communication receiver such that the other image is to be presented at the timing when the presentation time information added to the communication stream coincides with the criterion time, and

an image merger configured to merge a plurality of images decoded by the broadcast-receiver image decoder and the communication-receiver image decoder.

### DESCRIPTION OF REFERENCE NUMERALS

100 broadcast/communication facility
300 receiver apparatus
301 tuner
302 broadcast-receiver DeMUX
303 broadcast-receiver image buffer
304 broadcast-receiver image decoder
305 STC generator
307 network I/F
308 HTML browser
309 VOD player
310 streaming buffer
311 communication-receiver DeMUX
312 communication-receiver image buffer
313 STC adjuster
314 communication-receiver image decoder
315 image merger
316 host controller

1. A receiver apparatus, comprising:
a broadcast receiver capable of receiving one of a plurality of images as a broadcast stream via broadcasting, a time reference value being added to the plurality of images, the plurality of images being to be synchronized and reproduced;
a communication receiver capable of receiving the other of the plurality of images as a communication stream via a network;
a criterion time generator configured to generate criterion time based on the time reference value of the broadcast stream, the criterion time being used to generate timing to present the plurality of images; and
an adjuster configured to adjust the criterion time based on an amount of delay of the time reference value of the communication stream behind the criterion time.

2. The receiver apparatus according to claim 1, wherein
the adjuster is configured to adjust the criterion time based on the amount of delay of the time reference value of the communication stream received by the communication receiver for the first time.

3. The receiver apparatus according to claim 2, wherein
presentation time information is added to each predetermined unit of the broadcast stream, and presentation time information is added to each predetermined unit of the communication stream, and
the receiver apparatus further comprises
a broadcast-receiver image decoder configured to decode the broadcast stream received by the broadcast receiver such that the one image is to be presented at the timing when the presentation time information added to the broadcast stream coincides with the criterion time,
a broadcast-receiver image decoder configured to decode the communication stream received by the communication receiver such that the other image is to be presented at the timing when the presentation time information added to the communication stream coincides with the criterion time, and
an image merger configured to merge a plurality of images decoded by the broadcast-receiver image decoder and the communication-receiver image decoder.

4. The receiver apparatus according to claim 1, wherein
the adjuster is configured to adjust the criterion time based on a value obtained by adding a predetermined margin to an average value of the amounts of delay of the time reference values of the communication stream received by the communication receiver within a certain time period.

5. The receiver apparatus according to claim 4, wherein
presentation time information is added to each predetermined unit of the broadcast stream out of the broadcast stream and the communication stream, and
the receiver apparatus further comprises
a broadcast-receiver image decoder configured to decode the broadcast stream received by the broadcast receiver such that the one image is to be presented at the timing when the presentation time information added to the broadcast stream coincides with the criterion time,
a broadcast-receiver image decoder configured to decode the communication stream received by the communication receiver, and
an image merger configured to merge a plurality of images decoded by the broadcast-receiver image decoder and the communication-receiver image decoder.

6. A synchronization processing method, comprising:
receiving one of a plurality of images as a broadcast stream via broadcasting, a time reference value being added to the plurality of images, the plurality of images being to be synchronized and reproduced;
receiving the other of the plurality of images as a communication stream via a network;
generating, by a criterion time generator, criterion time based on the time reference value of the broadcast stream, the criterion time being used to generate timing to present the plurality of images; and
adjusting, by an adjuster, the criterion time based on an amount of delay of the time reference value of the communication stream behind the criterion time.
